(19) United States
(12) Patent Application Publication
(10) Pub. No.: US 2011/0084941 A1
(43) Pub. Date: Apr. 14, 2011

(54) SENSING DEVICE OF SURFACE ACOUSTIC WAVE TOUCH PANEL

(75) Inventors: SHANG-TAI YEH, Taipei City (TW); Teng-Wei Hsieh, Taipei City (TW)

(73) Assignee: EGALAX_EMPIA TECHNOLOGY INC., Taipei City (TW)

(21) Appl. No.: 12/970,358

(22) Filed: Dec. 16, 2010

Related U.S. Application Data
(63) Continuation-in-part of application No. 11/858,392, filed on Sep. 20, 2007.

(51) Int. Cl. G06F 3/043

(52) U.S. Cl. 345/177

(57) ABSTRACT

Described is a sensing device of a surface acoustic wave (SAW) touch panel having a new reflector columns and rows arrangement. As compared to the conventional design in the art where each of the reflector columns and rows are arranged from thinness to thickness, each of the arrangements of the reflector columns and rows herein is composed of a plurality of uniformly disposed reflectors having several sub-reflectors isolated with a gap or gaps.

### CROSS REFERENCE TO RELATED APPLICATIONS

This application claims the benefit of U.S. application Ser. No. 11/858,392, filed on 09/20/2007, which is herein incorporated by reference for all intents and purposes.

### BACKGROUND OF THE INVENTION

1. Field of the Invention

The present invention relates to a touch panel and particularly to a sensing device of a surface acoustic wave (SAW) touch panel in which the reflector columns and rows are each formed by uniformly arranged reflectors having a gap or gaps therein.

2. Description of the Prior Art

Surface acoustic wave (SAW) touch panel is a touch panel which determines a touch position thereon by detecting a vibration signal at a target position. Specifically, a transducer having a piezoelectric material therein is utilized to converse an electric signal into the vibration signal and whether the vibration signal is blocked from transmission by a touch at the touch position is judged for the touch position determination by referring to the received vibration signal, generally an output electric signal conversed from the received vibration signal, at the target position of the touch panel.

FIG. 1A is a schematic diagram of a structure of a conventional SAW touch panel. As shown in FIG. 1A, the touch panel 10 comprises a screen area 11 and a reflecting area 12 having a sensing device 13 therein. The sensing device 13 has a first and second X-axis transducers 14a, 14b and a first and second Y-axis transducers 15a, 15b. The second X-axis and Y-axis transducers 14b, 15b are used to receive vibration signals Signal_V 1 and Signal_V2 conversed from input electric signals Signal_Ei1 and Signal_Ei2 emitted from the first X-axis and Y-axis transducers 14a, 15a, respectively. In addition, the sensing device 13 also includes a first and second Y-axis reflecting units 16a, 16b and a first and second X-axis reflecting units 17a, 17b. Each of the first and second X-axis and Y-axis reflecting units 16a, 16b, 17a, 17b includes a plurality of reflector r each having the reflecting-in-part and transmitting-in-part characteristic. In this case, the vibration signals Signal V1 and Signal V2 required for detecting a touch position P on the X- and Y-axes of the screen area 11 can proceed along each of the first and second X-axis and Y-axis reflecting units 16a, 16b, 17a, 17b. In general, each of the reflectors r in the first and second X-axis and Y-axis reflecting units 16a, 16b, 17a, 17b is a line layer printed on a glass substrate of the touch 10 and thus has a low cost. In addition, the reflectors r in the first and second X-axis and Y-axis reflecting units 16a, 16b, 17a, 17b are arranged from thinnest to thickness (viewed from the proceeding directions of the vibrations Signal_V1 and Signal_V2, respectively), respectively. This is simply because when the thinness to thickness configuration of the reflecting units 6a, 16b, 17a, 17b is absent, the intensity of the vibration signals Signal_V 1 and Signal_V2, undesirably becomes smaller as the vibration signals Signal_V 1 and Signal_V2 proceed longer along a single respective X- or Y-axis reflecting units 16a, 16b, 17a, 17b, and thus the touch position sensing ability becomes weaker for the touch point P associated with the farer side of the single respective X- or Y-axis reflecting units 16a, 16b, 17a, 17b. Therefore, the thinness to thickness configuration is provided to each of the reflecting units 16a, 16b, 17a, 17b for compensation for this effect. FIG. 1B and FIG. 1C are waveform plots of Signal_Eo1 and Signal_Eo2 when the touch point P exists on and is absent from the SAW touch panel shown in FIG. 1A, respectively. As shown in FIG. 1B and FIG. 1C, Vy is the waveform of the output electric signal Signal_Eo1 and corresponds to an X-axis coordinate of the touch point P on the SAW touch panel 10. On the other hand, Vx is the waveform of the output electric signal Signal_Eo2 and corresponds to a Y-axis coordinate of the touch point P. It can be seen that the output electric signal Vx has a longer signal span than that of the output electric signal Vy. This is because the vibration signal Signal_V2 corresponding to the output electric signal Vx experiences a longer path than that of the vibration signal Signal_V1 corresponding to the output electric signal Vy. In FIG. 1C, there is a notch on the waveform of the output electric signal Vx and Vy, respectively, with which the touch position P may be determined. In addition, at the beginning of both the output electric signals Vy and Vx, there is a spike, which is resulted from the fact that the vibration signals Signal_V 1 and Signal_V2 from the input electric signals Signal_Ei1 and Signal_Ei2 are directly received by the second X-axis transducer 14b and the second Y-axis transducer 15b via the second X-axis reflecting unit 17b and second Y-axis reflecting unit 16b.

However, the SAW touch panel 10 having the thinness to thickness configuration also has its demerits. Owing to the thinner arrangement portion of the reflectors at each of the reflecting units 16a, 16b, 17a, 17b, the touch position P may sometimes associate with between two neighboring reflectors in a single reflecting units 16a, 16b, 17a, 17b. In this case, the determination of the touch position P on the SAW touch panel 10 is not ideal enough.

In this regard, the present invention sets forth a sensing device of a SAW touch panel, which may well overcome the problem encountered in the prior art.

### SUMMARY OF THE INVENTION

It is, therefore, an object of the present invention to provide a sensing device of a surface acoustic wave (SAW) touch panel, so as to overcome the problem encountered in the prior art.

The objectives of the present invention can be achieved by the following technical schemes. The present invention proposes a surface acoustic wave (SAW) touch panel, which includes: a substrate for providing transmission of a SAW; a reflector array including a plurality of pairs of reflectors, each pair of reflectors determining a path on the substrate, respectively, wherein these reflectors include a plurality of dashed-line reflectors, each dashed-line reflector including a plurality of sub-reflectors spaced apart by at least a gap; at least one transmitter for generating a SAW; and at least one receiver for generating a signal based on the SAW transmitted by each path, wherein the physical total length of the pair of reflectors that transmit the SAW on each path determines the amount of the SAW transmitted on the path.

The objectives of the present invention can further be achieved by the following technical schemes. The present invention proposes a method for configuring a reflector array of a surface acoustic wave (SAW) touch panel, which includes: providing a substrate for providing transmission of a SAW; determining the locations of a plurality of pairs of reflectors of the reflector array on the substrate; providing the reflector array based on the locations of the plurality of pairs of reflectors of the reflector array on the substrate, each pair of reflectors determining a path on the substrate, respectively, wherein these reflectors include a plurality of dashed-line reflectors, each dashed-line reflector including a plurality of sub-reflectors spaced apart by at least a gap; providing at least one transmitter for generating a SAW; providing at least one receiver for generating a signal based on the SAW transmitted by each path, wherein the physical total length of the pair of reflectors that transmit the SAW on each path determines the amount of the SAW transmitted on the path; and adjusting the total length of the gap of each dashed-line reflector based on the signal, so that the signal is maintained at a zero-value range during a detection period.

The objectives of the present invention can further be achieved by the following technical schemes. The present invention proposes a method for configuring a reflector array of a surface acoustic wave (SAW) touch panel, which includes: providing a substrate for providing transmission of a SAW; determining the locations of a plurality of pairs of reflectors of the reflector array on the substrate; providing the reflector array based on the locations of the plurality of pairs of reflectors of the reflector array on the substrate, each pair of reflectors determining a path on the substrate, respectively, wherein these reflectors include a plurality of dashed-line reflectors, each dashed-line reflector including a plurality of sub-reflectors spaced apart by at least a gap; providing at least one transmitter for generating a SAW; providing at least one receiver for generating a signal based on the SAW transmitted by each path, wherein the physical total length of the pair of reflectors that transmit the SAW on each path determines the amount of the SAW transmitted on the path; and adjusting the locations of these reflectors based on the signal, so that the signal is maintained at a zero-value range during a detection period.

The objectives of the present invention can further be achieved by the following technical schemes.

The physical total length of each said dashed-line reflector does not include the lengths of all the gaps.

In said reflector array, the closer a pair of reflectors is to the at least one transmitter and the at least one receiver, the longer the total length of all the gaps of the pair of reflectors.

The magnitude of said signal is determined based on the length of the path and the physical total length of the pair of reflectors that transmit the SAW.

The lengths of said reflectors are the same, wherein the length of each dashed-line reflector includes the lengths of all the gaps.

The heights of said reflectors are the same.

Separations between each reflector and its neighboring reflectors are equal.

Compared to the prior art, the reflector array provided by the present invention includes a plurality of dashed-line reflectors, such that the SAW can pass through the gaps of the dashed-line reflectors without being obstructed, thereby reducing the difference in intensities between the SAWs transmitted on each reflecting path, and the separations between reflectors can be made equal.

Since the reflectors in the first and second X-axis and Y-axis reflecting units of the sensing area of the SAW touch panel are uniformly arranged, the problem which a touch point can not be effectively sensed on the same touch panel associated with the thinly distributed reflectors can be overcome.

### BRIEF DESCRIPTION OF THE DRAWINGS

The above and other objects of the present invention will become readily apparent by reference to the following detailed description when considered in conjunction with the accompanying drawings, wherein:

FIG. 1A is a schematic structure for illustrating how a touch position made on a conventional surface acoustic wave (SAW) touch panel is detected;

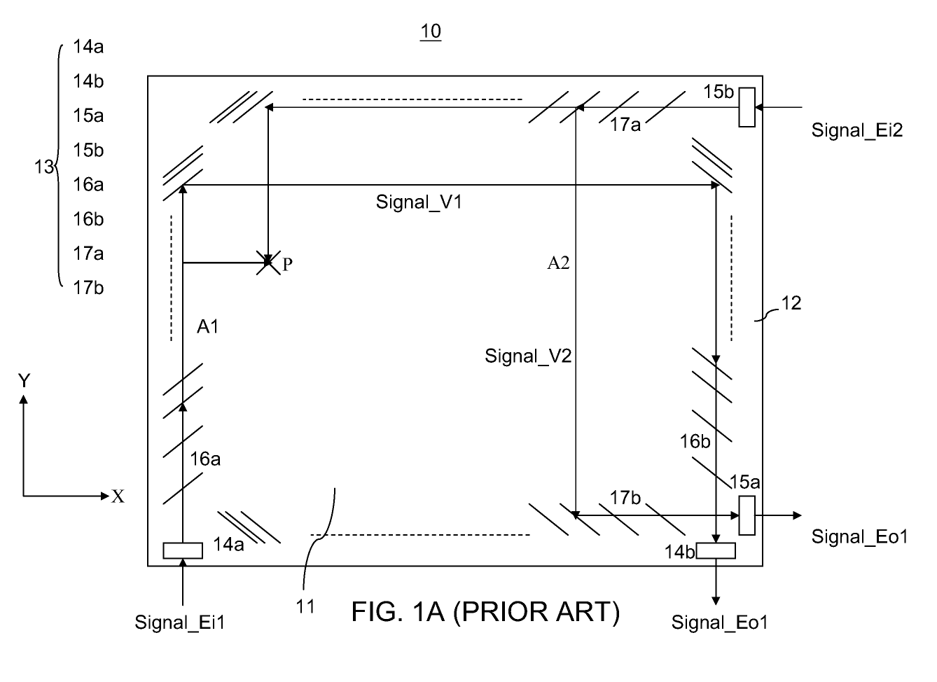

FIG. 1B is waveform plots of two output electric signals from the SAW touch panel shown in FIG. 1A when no touch input is impinged on the same, respectively;

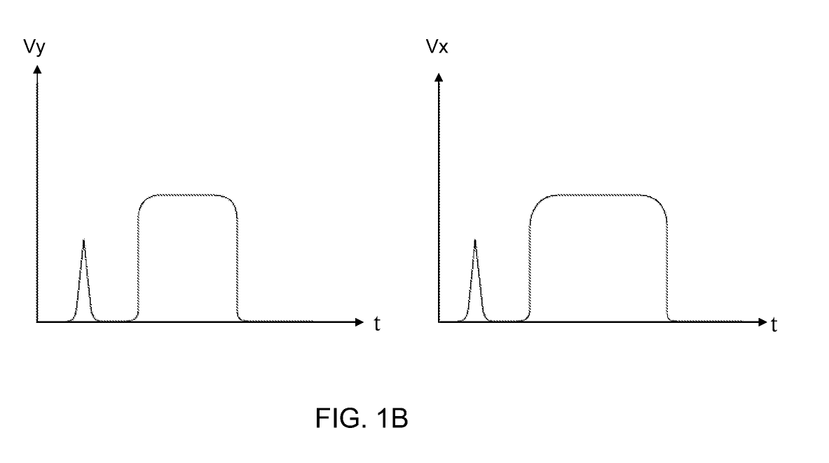

FIG. 1C is waveform plots of two output electric signals from the SAW touch panel shown in FIG. 1A when there is a touch input impinged on the same;

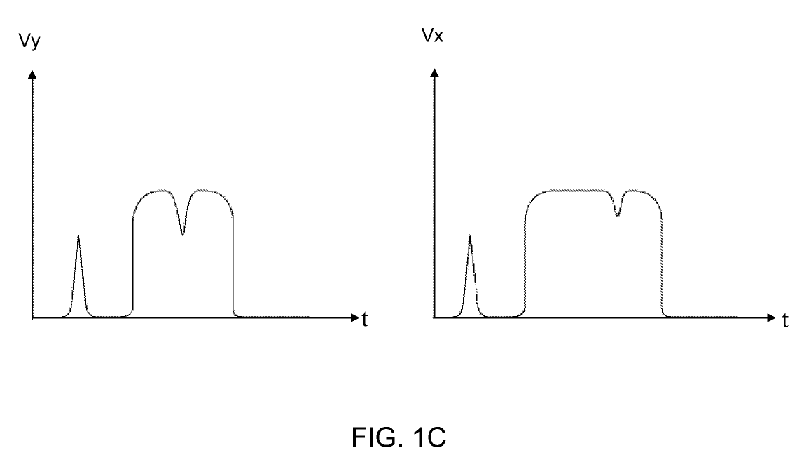

FIG. 2A is a schematic structure for illustrating how a touch position on a SAW touch panel according to the presenting invention is detected;

FIG. 2B is waveform plots of two output electric signals from the SAW touch panel shown in FIG. 2A when no touch input is impinged on the same, respectively; and

FIG. 2C is waveform plots of two output electric signals from the SAW touch panel shown in FIG. 2A when there is a touch input impinged on the same, respectively.

FIG. 3 is a flowchart illustrating a method for configuring the reflector array of the SAW touch panel according to the present invention; and

FIG. 4 is a flowchart illustrating another method for configuring the reflector array of the SAW touch panel according to the present invention.

### DETAILED DESCRIPTION OF THE PREFERRED EMBODIMENTS

The present invention is a sensing device of a surface acoustic wave (SAW) touch panel according to the present invention, and will be described taken in the preferred embodiments with reference to the accompanying drawings.

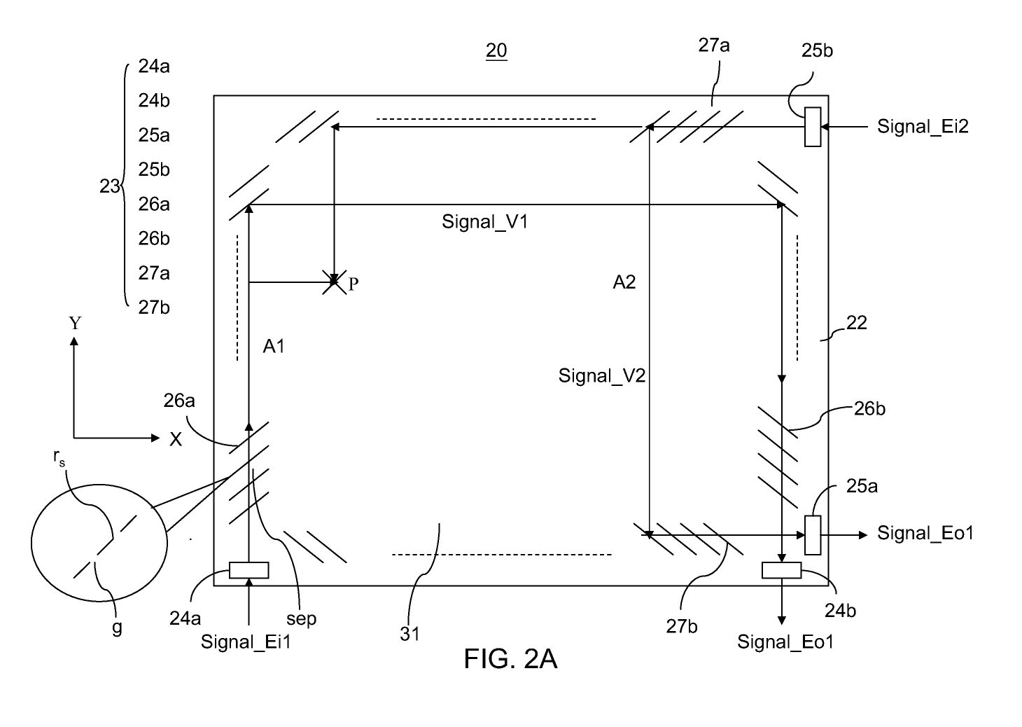

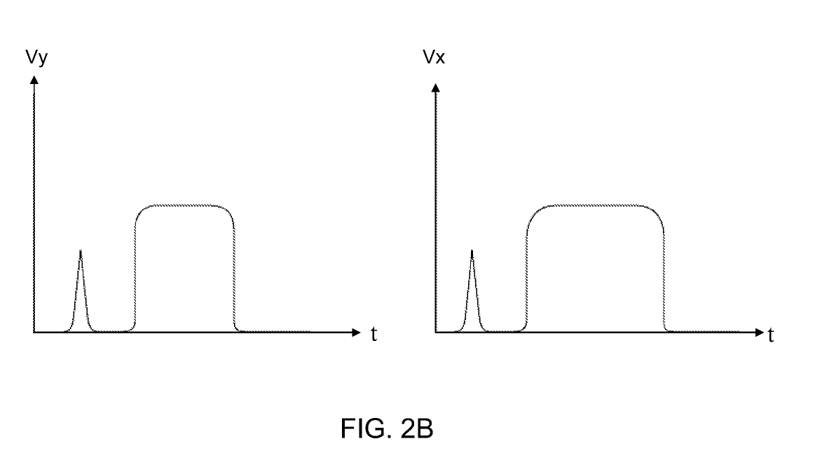

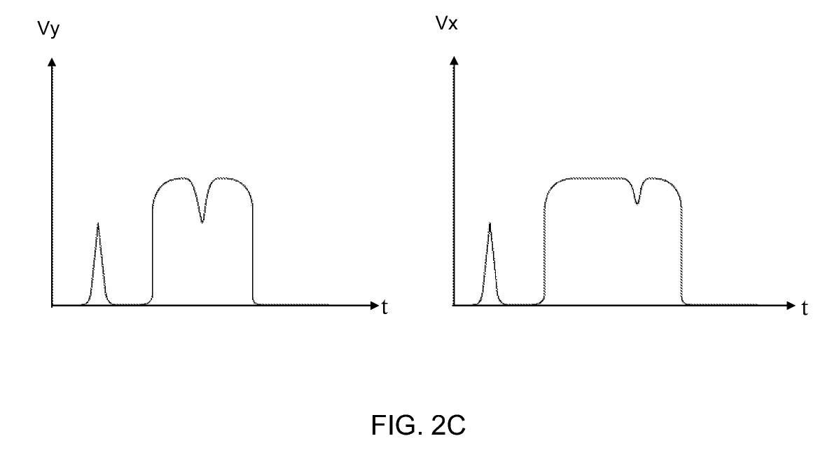

Referring to FIG. 2A, which a schematic structure for illustrating how a touch position on a SAW touch panel according to the present invention is detected. As shown, the SAW touch panel 20 is a rectangular device which may be measured with an X-axis and a Y-axis and has a screen area 21 and a reflecting area 22 at which a sensing device 23 is disposed. The sensing device 23 includes a first and second X-axis transducers 24a and 24b and a first and second Y-axis transducers 25a and 25b. The sensing area 23 further includes a first and second Y-axis reflecting units 26a and 26b and a first and second X-axis reflecting units 27a and 27b. The first and second Y-axis and X-axis reflecting units 26a, 26a, 27a, 27b are vertically or horizontally arranged circumferentially with respect to the screen area 21. The first and second Y-axis reflecting units 26a and 26b (also termed as the first and second reflecting columns herein) each include a first number of reflectors r while the first and second X-axis reflecting units 27a and 27b (also termed as the first and second reflecting rows herein) each include a second number of reflectors r. In addition, all or some of the reflectors r each have the transmitting-in-part and reflecting-in-part characteristic and each have a plurality of sub-reflectors rₛ each separated from the neighboring one or ones among the plurality of sub-reflectors rₛ with a gap g. The first and second X-axis reflecting units 27a and 27b and the first and second Y-axis reflecting units 26a and 26b are collectively called a reflector array. In addition, a reflector with at least one gap g in the form of a dashed line is called a dashed-line reflector. The lengths of these reflectors r are the same. The length of each dashed-line reflector includes the lengths of all the gaps. Compared to the dashed-line reflectors in the present invention, reflectors r used for reflecting vibration signals Signal V1 and Signal V2 in the prior art are solid-line reflectors.

In real operation, an electric signal Signal_Ei1 is inputted into the first X-axis transducer 24a of the SAW touch panel 20, in which the electric signal Signal_Ei1 is conversed into a vibration signal Signal_V1. The vibration signal Signal_V1 thus obtained then proceeds along the first Y-axis reflecting unit 26a where the vibration signal Signal_V1 is transmitted in part and reflected in part. The reflected portion of the vibration signal Signal_V1 is then further reflected by a corresponding reflector r in the second Y-axis reflecting unit 16b and finally received by the second X_axis transducer 24b after a proceeding path of the reflected vibration signal portion Signal_V1, depicted in FIG. 2A as A1, in which the vibration signal portion Signal_V1 is conversed into an output electric signal Signal_Eo1. Similarly but unconcurrently, an electric signal Signal_Ei2 is inputted to the SAW touch panel 20 at the first Y-axis transducer 25a, in which the input electric signal Signal_Ei2 is conversed into a vibration signal Signal_V2. The reflected portion of the vibration signal Signal_V2 is then further reflected by a corresponding reflector r in the second X-axis reflecting unit 17b and finally received by the second Y_axis transducer 25b after a proceeding path of the reflected vibration signal portion Signal_V2, depicted in FIG. 2A as A2, in which the vibration signal portion Signal_V2 is conversed into an output electric signal Signal_Eo2. Finally, the output electric signals Signal_Eo1 and Signal_Eo2 are relied upon to determine where the touch point P is located on the SAW touch panel 20 by referring to the input electric signals Signal_Ei1 and Signal_Ei2.

In the above, that the transducers 24a and 24b are operated at different time from that of the transducers 25a and 25b is made to prevent the vibration signals Signal_V 1 and Signal_V2 from interfering with each other. Correspondingly, the first and second input electric signals Signal_Ei1 and Signal_Ei2 are supplied alternatively to the first X-axis and Y-axis transducers 24a and 25a. As such, any possible touch position on the SAW touch panel 20 can be continuously detected.

In addition, the output electric signals Signal_Eo1 and Signal_Eo2 above mentioned have the waveforms Vy and Vx shown in FIG. 2B, respectively.

When a touch position P appears on and contacts with the screen area 21 of the SAW touch panel 20, the proceeding paths of the first and vibration signals Signal_V1 and Signal_V2 associated with the touch position P are blocked, the first and second output electric signals Signal_V1 and Signal_V2 each have a decreased level Vy and Vx, respectively, shown in FIG. 2C. By referring to the point of time the decreased levels Vy and Vx appears, a coordinate (X, Y) of the touch position P contacted with the screen area 21 of the SAW touch panel 20 can be determined.

Since the sub-reflectors rs is present, the vibration signals Signal_V1 and Signal_V2 which may be reflected by the reflectors r located at a rear part of each of the first and second Y-axis and X-axis reflecting units 26a, 26a, 27a, 27b (viewed from the directions that the vibration signals Signal_V1 and Signal_V2 outputted from the transducers 24a and 25a, respectively) remain at effective intensities. Namely, the vibration signals Signal_V1 and Signal_V2 reflected by the reflectors r located at the rear part of each of the first and second Y-axis and X-axis reflecting units 26a, 26a, 27a, 27b (viewed from the same directions) do not decrease is simply because the reflectors r of each of the first and second Y-axis and X-axis reflecting units 26a, 26a, 27a, 27b each have the gaps g and the vibration signals Signal_V1 and Signal_V2 can better transmit through a fore part of each of the first and second Y-axis and X-axis reflecting units 26a, 26a, 27a, 27b to the rear part of the same.

Therefore, in a best mode of the present invention, the SAW touch panel includes: a substrate for providing transmission of a SAW; a reflector array including a plurality of pairs of reflectors r, each pair of reflectors r determining a path on the substrate, respectively, wherein these reflectors r include a plurality of dashed-line reflectors, each dashed-line reflector including a plurality of sub-reflectors rₛ spaced apart by at least a gap g; at least one transmitter (e.g. the first x-axis transducer 24a or the first y-axis transducer 25a) for generating a SAW; and at least one receiver (e.g. the second x-axis transducer 24b and the second y-axis transducer 25b) for generating a signal based on a SAW transmitted by each path, wherein the physical total length of the pair of reflectors r that transmit the SAW on each path determines the amount of the SAW transmitted on the path, wherein the physical total length of each dashed-line reflector does not include the lengths of all the gaps g, and the magnitude of the signal is determined based on the length of each path (since the longer the path, the more reflectors the signal has to pass through) and the physical total length of the pair of reflectors r that transmit the SAW. In an example of the present invention, all the reflectors r are dashed-line reflectors. In another example of the present invention, at least one reflector r is not a dashed-line reflector. For example, one or more reflectors at the end of the paths of the vibration signals Signal V1 and Signal V2 are solid-line reflectors.

Compared to the prior art, since the reflectors r of the present invention have gaps g, the vibration signals Signal V1 and Signal V2 passing through the gaps g will not be obstructed and attenuated by reflectors r. Therefore, the size (length) of the gap g on each reflector r can be adjusted so as to allow the vibration signals Signal V1 and Signal V2 to maintain effective intensities when passing through each reflector. For example, on the paths of the vibration signals Signal V1 and Signal V2, the reflectors r the signals pass through earlier (closer to the first x-axis transducer 24a or the first y-axis transducer 25a) have larger gaps g, whereas the reflectors r the signals pass through later (closer to the second x-axis transducer 24b or the second y-axis transducer 25b) have smaller gaps g. As a result, assuming that the emission intensities of the vibration signals Signal V1 and Signal V2 are the same, and the height of each reflector r is the same, the intensities of the vibration signals Signal V1 and Signal V2 after passing through each reflector r will be greater than the prior art. In other words, the total length of all the gaps g of the reflectors that are closer to the transmitters and/or the receivers is longer.

Furthermore, the neighboring reflectors r of each of the first and second Y-axis and X-axis reflecting units 26a, 26a, 27a, 27b may be arranged with an equidistance, such as a separation sep, that is, the separations sep between each reflector and its neighboring reflectors are the same, without losing the ability to detect the touch position P on the SAW touch panel 20, owing to the provision of the sub-reflectors rₛ. In this manner, all the possible touch positions P on the SAW touch panel 20 can be located at the proceeding paths of the reflected portions of the vibration signals Signal_V1 and Signal_V2, respectively. Accordingly, any possible touch position P on the SAW touch panel 20 can be well detected, as contrasted to the case in the prior art where some possible touch positions P may appear between the two neighboring proceeding paths A1 or/and A2 with a relatively larger separation and thus can not be perfectly detected.

In a preferred embodiment, the separation sep of each of the neighboring reflectors of the first and second Y-axis and X-axis reflecting units 26a, 26a, 27a, 27b is set to be equal. Each of the neighboring sub-reflectors rₛ of each of the first and second Y-axis and X-axis reflecting units 26a, 26a, 27a, 27b and a relationship of the gaps among each of the sub-reflectors rₛ of the reflectors r of the first and second Y-axis and X-axis reflecting units 26a, 26a, 27a, 27b are dependent upon a material forming each of the reflectors r. Further, any one of all the gaps g has an optimal relationship with the other gaps of the reflectors r in the first and second Y-axis and X-axis reflecting units 26a, 26a, 27a, 27b obtained by experiment.

In an embodiment of the present invention, the reflector array on the SAW touch panel can be arranged in such a way that the gaps g between each sub-reflectors rₛ and the separations sep between each reflector r are configured according to penetration levels of the SAW with respect to various materials of the reflector.

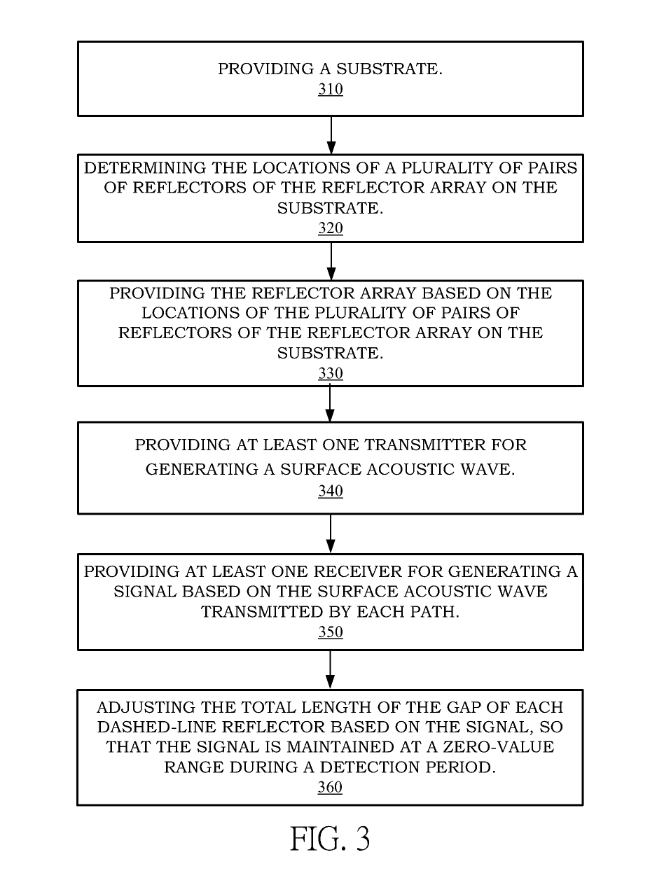

For example, a method for configuring the reflector array of the SAW touch panel according to the present invention is shown in FIG. 3. First, in step 310, a substrate is provided for providing transmission of a SAW. In addition, as shown in step 320, the locations of a plurality of pairs of reflectors r of a reflector array on the substrate are determined, and as shown in step 330, the reflector array is provided based on the locations of the plurality of pairs of reflectors r of the reflector array on the substrate. Each pair of reflectors r in the reflector array determines a path on the substrate, respectively, and these reflectors r include a plurality of dashed-line reflectors (all or some of the reflectors are dashed-line reflectors), and each dashed-line reflector includes a plurality of sub-reflectors rₛ spaced apart by at least a gap g. Further, in step 340, at least one transmitter is provided for generating a SAW, and as shown in step 350, at least one receiver is provided for generating a signal based on a SAW transmitted by each path, wherein the physical total length of the pair of reflectors r that transmit the SAW on each path determines the amount of the SAW transmitted on the path. Moreover, as shown in step 360, the total length of the gap g of each dashed-line reflector is adjusted based on the signal so that the signal is maintained at a zero-value range during a detection period. For example, when the signal on a path is greater than the zero-value range, the total length of the gaps g of the pair of reflectors r on this path is increased. On the contrary, when the signal on a path is smaller than the zero-value range, the total length of the gaps g of the pair of reflectors r on this path is decreased.

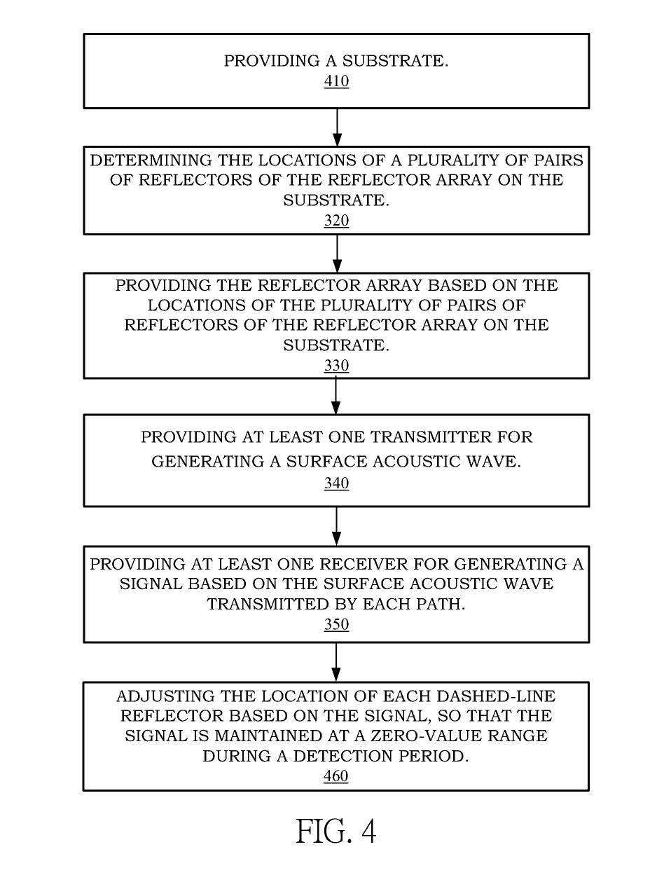

As another example, a method for configuring the reflector array of the SAW touch panel according to the present invention is shown in FIG. 4. First, in step 310, a substrate is provided for providing transmission of a SAW. In addition, as shown in step 320, the locations of a plurality of pairs of reflectors r of a reflector array on the substrate are determined, and as shown in step 330, the reflector array is provided based on the locations of the plurality of pairs of reflectors r of the reflector array on the substrate. Each pair of reflectors r in the reflector array determines a path on the substrate, respectively, and these reflectors r include a plurality of dashed-line reflectors (all or some of the reflectors are dashed-line reflectors), and each dashed-line reflector includes a plurality of sub-reflectors rₛ spaced apart by at least a gap g. Further, in step 340, at least one transmitter is provided for generating a SAW, and as shown in step 350, at least one receiver is provided for generating a signal based on a SAW transmitted by each path, wherein the physical total length of the pair of reflectors r that transmit the SAW on each path determines the amount of the SAW transmitted on the path. Moreover, as shown in step 460, the location of each dashed-line reflector is adjusted based on the signal so that the signal is maintained at a zero-value range during a detection period. For example, when the signal on a path is greater than the zero-value range, the pair of reflectors r on this path are shifted towards the first x-axis transducer 24a or the first y-axis transducer 25a (e.g. removing and regenerating reflectors) to shorten the path. On the contrary, when the signal on a path is smaller than the zero-value range, the pair of reflectors r on this path are shifted towards the second x-axis transducer 24b or the second y-axis transducer 25b to lengthen the path.

The detection period can be the period for detecting whether a touch exists as shown in FIGS. 2B and 2C.

In addition, each of the reflectors r has generally the form of a reflecting line layer made of ink. The reflecting line layer is fabricated on a transparent substrate (now shown), like the sensing device 23 by a printing method. In a preferred embodiment, the transparent substrate is a transparent glass substrate. In an example of the present invention, the height of each reflector r in the reflector array of the present invention is uniform, which can be manufactured all together by one common printing method.

In addition, the first and second input electric signals Signal_Ei1 and Signal_Ei2 can be supplied by a single external signal source (now shown). At this time, a switch may be provided to switch alternatively the signal external signal source to be the first and second input electric signals Signal_Ei1 and Signal_Ei2. In addition, each of the first and second input electric signals Signal_Ei1 and Signal_Ei2 takes the form of a signal consisting of bursts.

In the prior art, when the height of the reflectors r is uniform, the intensity of the SAW being reflected exhibits a gradient. This is because the SAW is gradually attenuated when passing through each reflector r. The amount of attenuation varies with the materials and the heights of the reflectors r. The difference between the intensities of the reflected SAWs affects the level of density of the reflectors r. The greater the difference between the intensities of the reflected SAWs, the greater the difference in the densities of the reflectors r. With the dashed-line reflectors provided by the present invention, the difference between the intensities of the reflected SAWs is minimized; moreover, even the densities of the reflectors can be made uniform.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A surface acoustic wave touch panel, comprising:
a substrate for providing transmission of a surface acoustic wave;
a reflector array including a plurality of pairs of reflectors, each pair of reflectors determining a path on the substrate, respectively, wherein these reflectors include a plurality of dashed-line reflectors, each dashed-line reflector including a plurality of sub-reflectors spaced apart by at least a gap;
at least one transmitter for generating a surface acoustic wave; and
at least one receiver for generating a signal based on the surface acoustic wave transmitted by each path, wherein the physical total length of the pair of reflectors that transmit the surface acoustic wave on each path determines the amount of the surface acoustic wave transmitted on the path.

2. The surface acoustic wave touch panel of claim 1, wherein the physical total length of each dashed-line reflector does not include the lengths of all the gaps.

3. The surface acoustic wave touch panel of claim 1, wherein the total length of all the gaps of the pair of reflectors closer to the at least one transmitter and the at least one receiver is longer.

4. The surface acoustic wave touch panel of claim 1, wherein the magnitude of the signal is determined based on the length of the path and the physical total length of the pair of reflectors that transmit the surface acoustic wave.

5. The surface acoustic wave touch panel of claim 1, wherein the lengths of these reflectors are the same, wherein the length of each dashed-line reflector includes the lengths of all the gaps.

6. The surface acoustic wave touch panel of claim 1, wherein the heights of these reflectors are the same.

7. The surface acoustic wave touch panel of claim 1, wherein separations between each reflector and its neighboring reflectors are equal.

8. A method for configuring a reflector array of a surface acoustic wave touch panel, comprising:
providing a substrate for providing transmission of a surface acoustic wave;
determining the locations of a plurality of pairs of reflectors of the reflector array on the substrate;
providing the reflector array based on the locations of the plurality of pairs of reflectors of the reflector array on the substrate, each pair of reflectors determining a path on the substrate, respectively, wherein these reflectors include a plurality of dashed-line reflectors, each dashed-line reflector including a plurality of sub-reflectors spaced apart by at least a gap;
providing at least one transmitter for generating a surface acoustic wave;
providing at least one receiver for generating a signal based on the surface acoustic wave transmitted by each path, wherein the physical total length of the pair of reflectors that transmit the surface acoustic wave on each path determines the amount of the surface acoustic wave transmitted on the path; and
adjusting the total length of the gap of each dashed-line reflector based on the signal, so that the signal is maintained at a zero-value range during a detection period.

9. The method of claim 8, wherein the physical total length of each dashed-line reflector does not include the lengths of all the gaps.

10. The method of claim 8, wherein the closer a pair of reflectors is to the at least one transmitter and the at least one receiver, the longer the total length of all the gaps of the pair of reflectors.

11. The method of claim 8, wherein the magnitude of the signal is determined based on the length of the path and the physical total length of the pair of reflectors that transmit the surface acoustic wave.

12. The method of claim 8, wherein the lengths of these reflectors are the same, wherein the length of each dashed-line reflector includes the lengths of all the gaps.

13. The method of claim 8, wherein the heights of these reflectors are the same.

14. The method of claim 8, wherein separations between each reflector and its neighboring reflectors are equal.

15. A method for configuring a reflector array of a surface acoustic wave touch panel, comprising:
providing a substrate for providing transmission of a surface acoustic wave;
providing the reflector array including a plurality of pairs, each pair of reflectors include a plurality of dashed-line reflectors, each dashed-line reflector including a plurality of sub-reflectors spaced apart by at least a gap;
providing at least one transmitter for generating a surface acoustic wave;
providing at least one receiver for generating a signal based on the surface acoustic wave transmitted by each path, wherein the physical total length of the pair of reflectors that transmit the surface acoustic wave on each path determines the amount of the surface acoustic wave transmitted on the path; and
adjusting the locations of these reflectors based on the signal, so that the signal is maintained at a zero-value range during a detection period.

16. The method of claim 15, wherein the physical total length of each dashed-line reflector does not include the lengths of all the gaps.

17. The method of claim 15, wherein the closer a pair of reflectors is to the at least one transmitter and the at least one receiver, the longer the total length of all the gaps of the pair of reflectors.

18. The method of claim 15, wherein the magnitude of the signal is determined based on the length of the path and the physical total length of the pair of reflectors that transmit the surface acoustic wave.

19. The method of claim 15, wherein the lengths of these reflectors are the same, wherein the length of each dashed-line reflector includes the lengths of all the gaps.

20. The method of claim 15, wherein the heights of these reflectors are the same.

21. The method of claim 15, wherein separations between each reflector and its neighboring reflectors are equal.
